(19) United States
(12) Patent Application Publication
(10) Pub. No.: US 2010/0033094 A1
(43) Pub. Date: Feb. 11, 2010

(54) FOIL FOR LAMPS AND ASSOCIATED POWER SUPPLY SYSTEM AND ELECTRIC LAMP WITH SUCH A RESPECTIVE FOIL AND ASSOCIATED PRODUCTION PROCESS

(75) Inventors: Thomas Heil, Schernfeld (DE); Georg Rosenbauer, Wassetruedingen (DE)

Correspondence Address: Viering, Jentschura & Partner - OSR, 3770 Highland Ave., Suite 203, Manhattan Beach, CA, 90266, US

(73) Assignee: Osram Gesellschaft mit beschraenkter Haftung, Muenchen (DE)

(21) Appl. No.: 12/538,200

(22) Filed: Aug. 10, 2009

(30) Foreign Application Priority Data
Aug. 11, 2008 (DE) 10 2008 037 319.2

(51) Int. Cl. H01J 17/18; B23P 17/00; B23K 11/00; H01B 5/00

(52) U.S. Cl. 313/623; 29/592.1; 219/78.01; 174/133 R

(57) ABSTRACT

A foil for lamp construction is provided with a substantially rectangular design with a longitudinal axis and a transverse axis. The foil may include at least one zone in its interior which comprises a plurality of structures arranged next to one another.

### CROSS-REFERENCE TO RELATED APPLICATION

This application claims priority to German Patent Application Serial No. 10 2008 037 319.2, which was filed Aug. 11, 2008, and is incorporated herein by reference in its entirety.

### TECHNICAL FIELD

Various embodiments are based on a foil for lamps which use a foil seal. This may be a fuse seal or a pinch seal. The lamps may be e.g. halogen incandescent lamps or high-pressure discharge lamps. In addition, various embodiments relate to such lamps and also to a process for manufacturing a power supply system with such a foil.

### BACKGROUND

Normally, foils are welded to the associated power supply lines, which pass into the interior or exterior of a bulb of a lamp, with auxiliary means such as welding pastes or welding strips (usually Pt) or coatings of the foil such as Ru being used; see DE-A 1996155 1. On the other hand, purely mechanical holding methods (clamping of the foil or folding of the foil) are also tried and tested. In EP-A 944 112, the foil has been trimmed and turned.

### SUMMARY

Various embodiments provide an improved concept for a foil which is machine-friendly and makes it possible for the power supply lines to be connected simply and securely. Furthermore, various embodiments provide a power supply system as well as a lamp, which can both be produced simply and inexpensively. Furthermore, various embodiments specify a process for manufacturing each of these.

According to various embodiments, the foil may be equipped with a zone of slits which are produced within the foil. The zone may include at least three slits, which are arranged next to one another.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the invention. In the following description, various embodiments of the invention are described with reference to the following drawings, in which:

FIG. 1 shows a halogen incandescent lamp with a foil in accordance with an embodiment;

FIG. 2 shows a foil with a zone of slits in accordance with an embodiment;

FIG. 3 shows a discharge lamp with a zone of grooves in accordance with an embodiment;

FIG. 4 shows another embodiment of a zone of slits; and

FIG. 5 shows another embodiment of a zone of slits.

### DESCRIPTION

The following detailed description refers to the accompanying drawings that show, by way of illustration, specific details and embodiments in which the invention may be practiced. These embodiments are described in sufficient detail to enable those skilled in the art to practice the invention. In this regard, directional terminology, such as “top”, “bottom”, “front”, “back”, “leading”, “trailing”, etc, is used with reference to the orientation of the Figure(s) being described. Because components of embodiments can be positioned in a number of different orientations, the directional terminology is used for purposes of illustration and is in no way limiting. Other embodiments may be utilized and structural, logical, and electrical changes may be made without departing from the scope of the invention. The various embodiments are not necessarily mutually exclusive, as some embodiments can be combined with one or more other embodiments to form new embodiments. The following detailed description therefore, is not to be taken in a limiting sense, and the scope of the present invention is defined by the appended claims.

The word “exemplary” is used herein to mean “serving as an example, instance, or illustration”. Any embodiment or design described herein as “exemplary” is not necessarily to be construed as preferred or advantageous over other embodiments or designs.

According to various embodiments, a foil may be equipped with a zone of slits which are produced within the foil. The zone may include at least three slits, which are arranged next to one another. An array of approximately 10 to 25 slits is typical and particularly effective. The slits may be arranged parallel to one another. The array may be rectangular, for example. The slits may be arranged at an angle with respect to the longitudinal axis of the foil. In various embodiments, the foil itself is rectangular.

The dimensions of the slits may be selected in such a way that they are matched to a power supply line to be fastened on the foil. A suitable power supply line is a thin wire; the power supply line may be a wire with a single or else a double coil. The best results are achieved with a wire with a single coil.

The slits may be produced most easily by means of laser treatment. By way of example, a pulsed Nd-YAG microprocessing laser with a high beam quality is used for this purpose.

The width d of the slits may in this case be in the range from about 5 μm to about 200 μm; e.g. it may be at most 100 μm. The spacing f between the slits may be in the range from about 50 μm to about 500 μm, e.g. in the range from about 100 μm to about 400 μm. In this case, f may be at most equal to 5 AD, where AD is the outer diameter of the power supply line to be fastened. In practice, in the case of a single wire this may be the diameter of the wire, and in the case of a power supply line with a single coil this may be the outer diameter of the primary winding. This choice of dimensions for the zone ensures that a series of parameters for the welding is decisively improved:

The transfer resistance may be increased purely geometrically.

The transfer resistance may be increased even further by spontaneous oxidation of the edges of the slits. Oxidation may in this case be generally also sometimes intended to mean oxidation, molybdenum spatter and smoke tracks.

The fusing of the foil, which may be produced from molybdenum or doped molybdenum, is successful more easily since, during the subsequent resistance welding for connecting the foil to the power supply line, the degree of lateral heat dissipation is lower. The risk of the power supply line to be welded vaporizing or remaining adhesively bonded to the upper welding electrode may thereby reduced or minimized. The lower welding electrode may be arranged beneath the foil and is not of importance.

The fusing of the foil may also be facilitated since the effectively active cross section of the foil is smaller.

Under these circumstances, the parameters for the welding can be improved or optimized in a targeted manner by the number, width and spacing of the slits in each case with respect to a specific power supply line. There is no need for any expensive additional materials such as welding pastes or welding strips. Time-consuming coatings and the time for dabbing with pastes or for folding the foil are also not required. In addition, there is the advantage that existing machines can be converted to the new process with little complexity.

The foils used for this purpose may be conventional foils used in lamp construction, with a molybdenum foil which has possibly been doped in a suitable manner being provided, for example, as has likewise been known for a long time as such. Typical dimensions for various implementations of the foil are as follows: the width may be 3 mm and the length may be 7 mm. In various implementations, the thickness may be 30 μm. The array of the slits may have a dimension of a width of 2 mm and a length of 0.8 mm. It is to be noted that other dimensions may also be provided in alternative implementations of various embodiments, if desired.

An excess consumption of foil material may therefore not be required, in contrast to the folding process.

The foil treated in this way may be used in bulbs made from quartz glass. Lamps with such bulbs may be incandescent lamps or discharge lamps.

The process of manufacturing may have the following steps:

First, in the region of the future welded joint of a foil, a zone of slits is cut out. This may take place with the aid of a laser beam, which is directed through a scanner optical element. However, it may also be produced mechanically. This process can of course also be used on the other side of the foil, where the outer feed line joins. During thermal cutting by means of high-energy-rich laser radiation, inert gas can additionally be used for flushing in order to influence the degree of oxidation on the foil in a targeted manner.

Laying of the power supply line onto the foil, with the power supply line coming to lie on the zone.

Welding of the power supply line to the foil, with resistance welding e.g. being used.

Various embodiments are suitable for a joint made by means of welding or else soldering between an inner or outer power supply line and a foil. In this case, it may be even sufficient in the simplest case for the structure of the zone on the foil not to be achieved with slits but purely by means of a pretreatment of the foil which results in fusing in the form of strokes or else in the form of a grid. A combination of pure fusing and slits is of course also suitable.

An effect of such a pretreatment may be the fact that the molybdenum of the foil fuses more easily during welding since the welding cross section is smaller. In addition, less heat is discharged at the welded joint of the power supply line via the foil. By way of example, the inner power supply line may be a filament or a filament with a core wire. It may also be provided that the transfer resistance at the cut edges assumes a well-defined value.

Such a zone can also be combined with other measures such as a foil lug, for example, by virtue of first a zone of slits or fused portions being produced and then part of the foil being cut open in the manner of a window around this region of the zone.

Various embodiments may be suitable in particular for connecting the foil to the inner power supply line since the diameters thereof are normally relatively small, with the result that the welding of this power supply line may be critical. Typical diameters of the wire of the power supply line may be down to 15 μm; in the case of a primary winding, the outer dimensions are down to approximately 50 μm. However, various alternative embodiments can of course also be used alone or in addition to the connection of the foil to the outer power supply line.

The foil material itself is that which is conventionally used in lamp construction, such as, for example, molybdenum or doped or coated molybdenum or else tantalum, etc. The thickness and shape of the foil can also be selected in conventional fashion. Typical are a few tens of μm and a lancet shape of the foil.

Such foils themselves are typically cut so as to be substantially rectangular, with a longitudinal side, which may be parallel to the subsequent lamp axis, and a shorter transverse side, which may be transverse with respect to the subsequent lamp axis. Deviations from this rule are of course possible and do not affect the basic concept of various embodiments.

According to various embodiments, at least one zone is cut out in the foil. This can be achieved by means of punching or else with the aid of high-energy radiation, for example from a laser. Typical cutting times per foil are below one second. The slit may have a width in the range from about 5 μm to about 250 μm. The basic shape of the slit is usually rectangular, but it may have any other desired shapes, such as triangular, corrugated or rounded off, for example. It may be provided that the width at one point is matched to the power supply line as described above.

At high cutting speeds and in particular at the beginning and end of a laser cut, it arises that the cutting gap at some points is not completely cut through. These fine webs within the laser cut usually have a rounded-off shape since the pulsed Nd-YAG laser with the downstream laser scanner optical element produces the slits in such a way that one point is separated out or sublimated out per laser pulse. Generally, these laser points overlap one another as a result of the high pulse frequency in the kilohertz range in such a way that, typically, a corrugated cut contour is produced. Relatively high cutting speeds result in the individual points no longer overlapping one another and therefore a small rounded-off web remaining within the cutting gap. In an extreme case, even a maximum web spacing s between the points can be set which is in the range of from 1 d to 3 d of the cutting gap width d.

Owing to the dynamics of the laser scanner head, the web spacing can vary within a cutting line. Depending on the laser type and the manufacturer, it may be that the web width becomes smaller towards the start and towards the end of the line or disappears entirely. When the slits are separated out, cutting speeds of up to 5000 mm/sec can be reached. In general, there may therefore usually be a combination of purely slits and of slits interrupted by webs.

A plurality of such zones, e.g. two, can be fitted on a foil, if appropriate. As a result, either a plurality of power supply lines can be held mechanically at the same time or the way in which a power supply line is held by these further slits can be improved by means of second welding.

The slit is cut out along the cut edge for example by means of mechanical punching or by high-energy means such as plasma or laser radiation. The specific way in which the slit is cut out is irrelevant. However, high-energy means may be used for rapid and simple machining.

The system in accordance with various embodiments may be very suitable for metal-halide lamps or halogen incandescent lamps, but may also be suitable variously for other purposes.

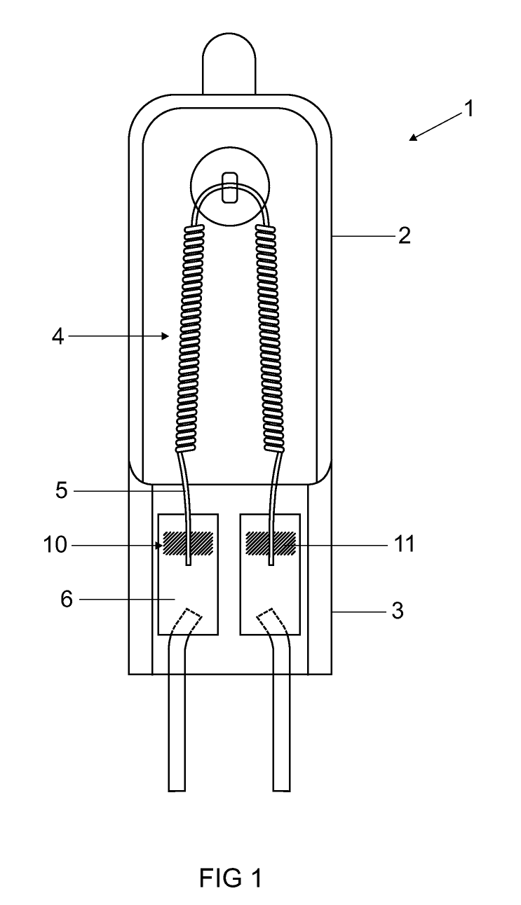

FIG. 1 shows an embodiment of a halogen incandescent lamp 1. It has a bulb 2 made from quartz glass which is sealed off with a pinch seal 3. A light-emitting element 4, which is connected to in each case one foil 6 in the pinch seal 3 via two inner power supply lines 5, is fitted in the interior of the bulb 2. The power supply lines may be made from a metal such as e.g. tungsten or molybdenum or the like and may have a diameter in the range from about 15 μm to about 200 μm, depending on the wattage of the lamp. The bulb 2 may contain a conventional halogen-containing fill. The type of fill is not important here. Instead of a light-emitting element, the bulb 2 may also contain two electrodes.

The foil 6 may in each case be made of molybdenum. It has a zone 10 of grooves 11 which are structured parallel to one another in the region of the half facing the interior of the bulb 2. The inner power supply line 5 is passed over the zone and welded to the foil 6 there. This power supply line may be a wire with a single coil (primary winding).

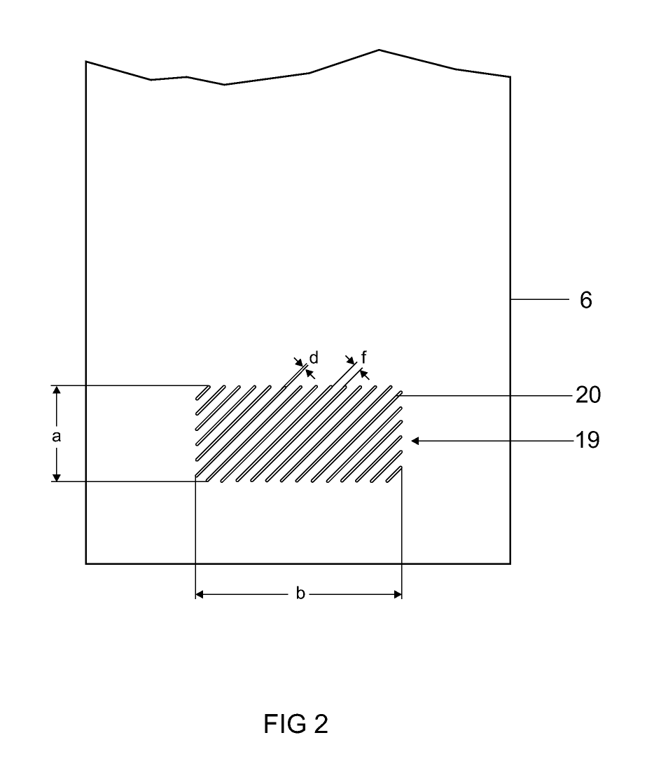

FIG. 2 shows a detail of a foil 6 with a zone 19 of slits 20. In this case, d is the width of a slit and f is the spacing between two slits. Typically, approximately 10 to 25 slits are arranged in identical fashion in a rectangular zone with the width b and the length a. In this case, the slits themselves are inclined through 45° with respect to the longitudinal direction of the foil. This means that as many slits as possible cross the power supply line. This usually means that the length of the slits is different. However, it is not impossible for the length of the slits to be identical, with the result that the zone itself is at an angle with respect to the longitudinal axis.

It is also not impossible for the parameters d and f to change within the zone. This can be achieved by the laser beam being inclined (laterally or longitudinally). As a result of the different spacings of the foil surfaces with respect to the laser optical element, the focus diameter of the beam on the Mo foil and therefore also the cutting gap width d changes.

However, it is also possible, for example, for the spacing f to be changed within a zone in a targeted manner in order to achieve, for example, approximately identical volume elements between two webs. It is thus possible for the lancet-shaped cross section of the Mo foil with the edges which are becoming thinner to also be taken into consideration in approximate fashion.

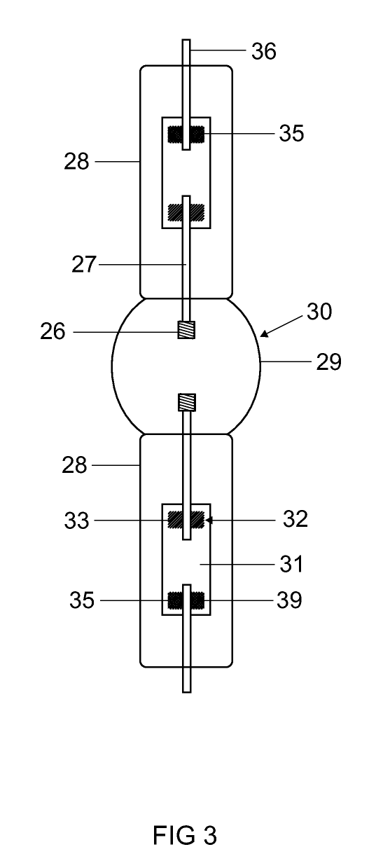

FIG. 3 shows a further embodiment of a high-pressure discharge lamp 30 with a metal-halide fill, known per se. In this case, the foil 31 has not been treated in such a way that slits are produced, but instead only one structured zone 32 is produced. In this case, the laser power is set at a lower level, with the result that only grooves 33 are produced instead of slits on the surface of the foil, with the foil having been partially fused or else only partially oxidized in said grooves and having been roughened in the process. Combinations of slits and grooves are also possible. In general, however, grooves may produce poorer results than slits since in this case the effects according to various embodiments may be less pronounced.

In this case, the foil 31 may be used for sealing on the basis of a fuse seal, with the discharge vessel 29 made from quartz glass having been provided with two cylindrical necks 28, which contain the foils 31. The inner power supply lines are in this case shafts 27, which end at electrodes 26.

By way of example, the foil 31 may in this case be equipped with two zones, one zone 32 for the electrode shaft as the inner power supply line and one zone 35 for the outer power supply line 36.

The zone 35 for the outer power supply line is in this case equipped with grooves 39 arranged in the form of a grid. This embodiment may not be realized with slits. In this case, first a zone of parallel partially fused grooves is produced by means of a laser. Then, the angle is changed and a second zone of partially fused grooves is produced on top of this. The parameters for the two zones can in this case be different, i.e. in particular d and f can be selected to be different from one another.

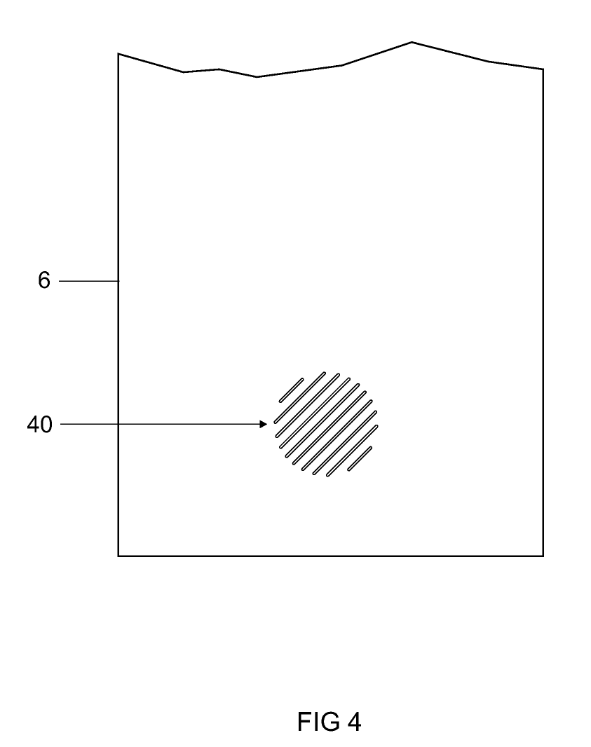

FIG. 4 shows an embodiment of a foil 6, with the zone 40 of slits being arranged so as to be round.

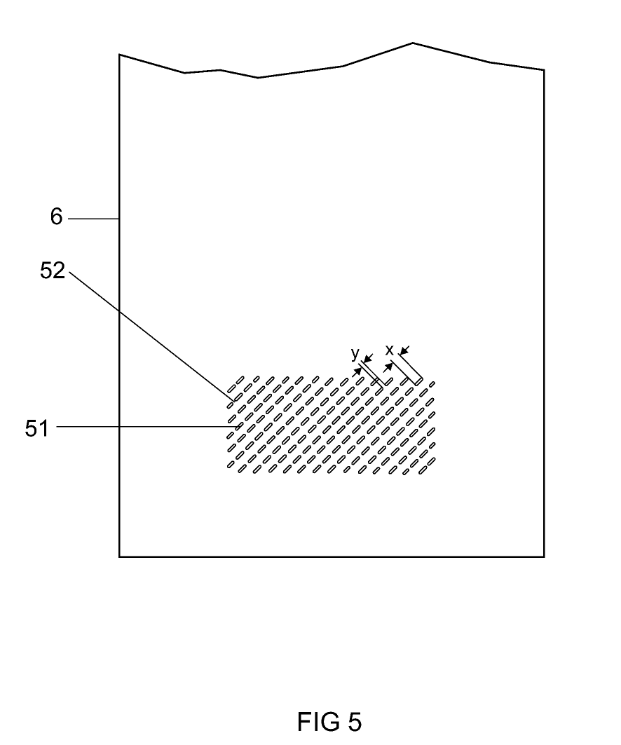

FIG. 5 shows a further embodiment of a foil 6, in which slits 51 are used which are interrupted by webs 52. The length of the slit parts 51 is denoted by x. The length of the interruptions or webs 52 is denoted by y. Such a design may improve the stability of the foil and, in the case of relatively high wattage lamps, can reduce the current density in the regions between the slits. Good results may be achieved if the ratio of x:y is in the range of from 0.3:1 to 3:1. Owing to the dynamics of the laser, these figures do not apply generally for all slits, but only for a central region of the zone, in particular for the central third of the length of a slit in the case of all of those slits in the zone which have a maximum length and as a result do not lie at the edge of the zone. The cutting speeds are from 10 mm/sec to 10 000 mm/sec. In this case, a point-to-point overlap is no longer continuously ensured. This results in slits or holes lying one behind the other, as shown in FIG. 5. A typical pulse frequency of the laser is in this case from 2 kHz to 100 kHz. A typical diameter of an individual hole may be in the range from about 5 μm to about 50 μm in accordance with various embodiments. The spacing between the individual holes may in this case often be in the range from the diameter of the hole up to three times this diameter or the smaller dimension of the longitudinal slit. A typical arrangement of the slit zone on the foil may be a 3 mm-wide foil, with the spacing between the zone and the edge of the foil in each case being approximately 0.5 mm to 1 mm.

The slits or grooves are produced most easily by means of high-energy radiation, such as by means of an Nd:YAG laser or CO₂ laser, for example, with an extremely small focus beam diameter of below 0.5 mm.

By way of example, this laser is operated in the pulsed-operation mode and the laser beam is guided by means of a scanner optical element or by means of a micromirror.

The production of the slits by means of laser machining etc. can take place both prior to and after the chemical edge etching of the Mo strip. That is to say that the laser machining is possible firstly on the finished Mo foil, and secondly on the semifinished unetched Mo strip (rolled Mo wire and rolled Mo sheet). Although in this case some of the smoke tracks/spatter/oxidation points are etched away, the elevation of the lateral cut edges is still provided. The advantage of this may be that slight oxidation points/smoke are etched away and the internal stresses which are introduced into the Mo foil as a result of the laser machining disappear after the chemical etching and stress-relieving annealing and purification annealing of the finished Mo foil.

While the invention has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

What is claimed is:

1. A foil for lamp construction with a substantially rectangular design with a longitudinal axis and a transverse axis, the foil comprising:
at least one zone in its interior which comprises a plurality of structures arranged next to one another.

2. The foil as claimed in claim 1,
wherein the plurality of structures comprises at least three structures arranged next to one another.

3. The foil as claimed in claim 1,
wherein at least some of the structures are slits.

4. The foil as claimed in claim 1,
wherein at least some of the structures are grooves comprising partially fused portions.

5. The foil as claimed in claim 1,
wherein at least some of the structures are grooves comprising oxidized regions.

6. The foil as claimed in claim 2,
wherein the slits are arranged so as to be inclined or at an angle with respect to the longitudinal axis of the foil.

7. The foil as claimed in claim 6,
wherein the slits are arranged so as to be inclined or at an angle with respect to the longitudinal axis of the foil in an angle range of from 10° to 90°.

8. The foil as claimed in claim 1,
wherein the individual structures are regular in terms of their width d and their spacing f.

9. The foil as claimed in claim 1,
wherein the foil is made of a metal.

10. The foil as claimed in claim 1,
wherein the foil is made of a metal selected from a group of metals consisting of undoped molybdenum, doped molybdenum, and tantalum.

11. The foil as claimed in claim 2,
wherein at least some of the slits are interrupted by webs.

12. The foil as claimed in claim 11,
wherein the ratio of the length x of the web parts and the length y of the webs in a central region are in the range of from 0.3:1 to 3:1.

13. A power supply system for a lamp, the power supply system comprising:
a foil; and
at least one power supply line connected to the foil,
the foil comprising at least one zone in its interior which comprises a plurality of structures arranged next to one another being connected to the power supply line by virtue of the fact that the power supply line bears against the foil in the region of the zone and is welded to the foil.

14. The power supply system as claimed in claim 13,
wherein the power supply line is welded to the foil by means of resistance welding.

15. The power supply system as claimed in claim 13,
wherein the power supply line is a primary winding.

16. The power supply system as claimed in claim 13,
wherein the maximum spacing f between the structures of the plurality of structures corresponds at most to 5 times the outer diameter of the power supply line.

17. An electric lamp, with a bulb made of glass and containing a fill and at least one seal as well as a light-emitting means fitted in the bulb, the light-emitting means being connected to a foil in the seal via an inner power supply line, and the foil being connected to an outer power supply line, wherein the foil comprises at least one zone in its interior which comprises a plurality of structures arranged next to one another, and at least one of the power supply lines is welded to the foil in the region of the zone.

18. A method for manufacturing a power supply system,
the power supply system comprising:
a foil; and
at least one power supply line connected to the foil,
the foil comprising at least one zone in its interior which comprises a plurality of structures arranged next to one another being connected to the power supply line by virtue of the fact that the power supply line bears against the foil in the region of the zone and is welded to the foil;
the method comprising:
producing a zone of structures on the foil in the region of the point at which the power supply line will be fastened;
laying the power supply line against the foil, with the power supply line also bearing in the region of the zone; and
fastening the power supply line to the foil by means of a welding operation.

19. The method as claimed in claim 18,
wherein the fastening takes place by means of resistance welding.
